(19) United States
(12) Patent Application Publication
(10) Pub. No.: US 2026/0093142 A1
(43) Pub. Date: Apr. 2, 2026

(54) MULTI-ZONE ELECTRONIC PRIVACY FILTER

(71) Applicant: LENOVO GLOBAL TECHNOLOGY (UNITED STATES) INC., MORRISVILLE, NC (US)

(72) Inventors: ZANE M ALI, ORANGEVALE, CA (US); BENJAMIN A FRISCH, ORLANDO, FL (US); JORDAN FERGUSON, AUSTIN, TX (US); EDWARD JAMES SACKINGER, RALEIGH, NC (US)

(21) Appl. No.: 18/898,824

(22) Filed: Sep. 27, 2024

(51) Int. Cl. G02F 1/1335; G06F 21/84

(52) U.S. Cl. CPC G02F 1/133509; G02F 1/133528; G06F 21/84

(57) ABSTRACT

Methods, systems, and apparatus for a multi-zone electronic privacy filter include a processor, a screen, and a multi-zone electric privacy filter coupled to the screen, where the multi-zone electric privacy filter includes: multiple zones, and a filter controller configured to control which of the multiple zones of the multi-zone electric privacy filter are enabled.

### BACKGROUND

### Field of the Disclosure

The field of the disclosure is data processing, or, more specifically, methods, systems, and apparatus for a multi-zone electronic privacy filter.

### Description of Related Art

Electronic privacy filters may be embedded into a computing system or may be coupled to, and overlay the screen of, the computing system. Such electronic privacy filters may limit the viewing angle of the screen beneath it, or may block the screen entirely. However, there may be situations where a user wants to provide privacy to only a portion of the screen. Accordingly, an improved electronic privacy filter design is required.

### SUMMARY

Methods, apparatus, and systems for a multi-zone electronic privacy filter according to various embodiments are disclosed in this specification. In accordance with one aspect of the present disclosure, a system configured with a multi-zone electronic privacy filter may include a processor, a screen, and a multi-zone electric privacy filter coupled to the screen, where the multi-zone electric privacy filter includes: multiple zones, and a filter controller configured to control which of the multiple zones of the multi-zone electric privacy filter are enabled.

In accordance with another aspect of the present disclosure, a method of filtering a screen via a multi-zone electronic privacy filter may include receiving, by a filter controller included within a privacy filter, a bitmap from a computing system, where the privacy filter is coupled to a screen of the computing system; and enabling one or more of a plurality of zones of the privacy filter based on the bitmap.

The foregoing and other objects, features and advantages of the disclosure will be apparent from the following more particular descriptions of exemplary embodiments of the disclosure as illustrated in the accompanying drawings wherein like reference numbers generally represent like parts of exemplary embodiments of the disclosure.

### BRIEF DESCRIPTION OF THE DRAWINGS

FIG. 1 shows an example line drawing of a system configured for a multi-zone electronic privacy filter in accordance with embodiments of the present disclosure.

FIG. 2 shows an example line drawing of a screen and an overlayed multi-zone electronic privacy filter according to some embodiments of the present disclosure.

FIG. 3 shows an example line drawing of another screen and an overlayed multi-zone electronic privacy filter according to some embodiments of the present disclosure.

FIG. 4 is a flowchart of an example method for controlling a multi-zone electronic privacy filter according to some embodiments of the present disclosure.

FIG. 5 shows an example line drawing of another system configured for a multi-zone electronic privacy filter in accordance with embodiments of the present disclosure.

FIG. 6 shows an example line drawing of another system configured for a multi-zone electronic privacy filter in accordance with embodiments of the present disclosure.

### DETAILED DESCRIPTION

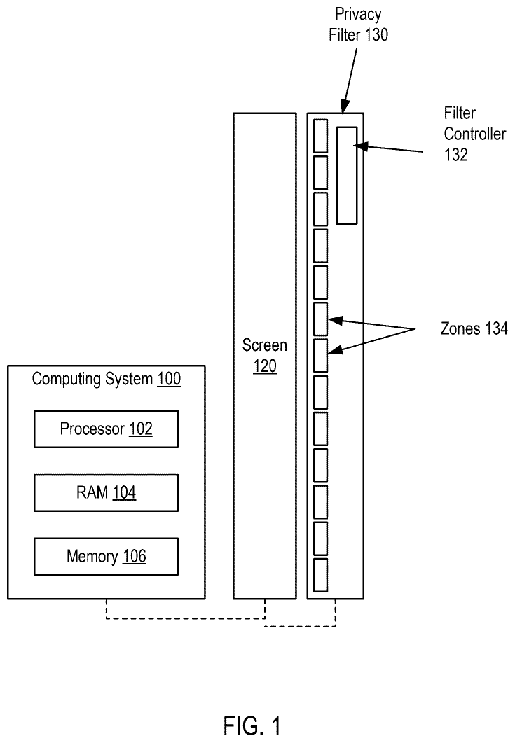

Exemplary methods, systems, and products for a multi-zone electronic privacy filter in accordance with the present disclosure are described with reference to the accompanying drawings, beginning with FIG. 1. FIG. 1 sets forth an example line drawing of a system configured for a multi-zone electronic privacy filter in accordance with embodiments of the present disclosure. The example of FIG. 1 includes a computing system 100, a screen 120 coupled to the computing system, and a privacy filter 130 coupled to the screen.

The example computing system 100 of FIG. 1 includes a processor 102, random access memory (RAM) 104, and memory 106. The computing system may include any number of other computing components. The computing system 100 of FIG. 1 is coupled to a screen 120 to display text or graphics to a user. The screen 120 may be any type of computer screen, such as an LCD screen, LED, OLED, or the like.

The example privacy filter 130 of FIG. 1 is configured to filter light emitted from the screen 120 to provide privacy to the user of the screen 120. The privacy filter 130 may be coupled to, integrated within, or positioned to overlay, the screen 120 of the computing system 100. For example, in some embodiments, the privacy filter 130 is added to the computing system 100 as an upgrade, where the privacy filter 130 is communicatively coupled to the computing system 100 and positioned to overlay the screen 120. In another embodiment, the privacy filter 130 is integrated as part of the screen 120, overlaying the pixels of the screen 120. In one embodiment, the privacy filter 130 is configured to limit the viewing angle of the screen 120 (at specific portions of the screen 120) so that people not directly in front of the screen 120 cannot see the contents of the screen 120 at the specific portions of the screen 120 where the privacy filter 130 is active, while the user of the screen 120 (positioned in front of the screen 120) can still view the contents of the entire screen 120 (including the portions of the screen 120 where the privacy filter 130 is active).

The example privacy filter 130 includes multiple filter zones (such as zones 134) and a filter controller 132. Each of the zones 134 includes components for providing privacy to the user of the screen 120. In one embodiment, each zone 134 includes one or more electronic polarizers, where enabling a zone 134 activates the electronic polarizers within the zone 134 to limit the viewing angle of the portion of the screen overlayed by the enabled zone 134. In another embodiment, each zone 134 includes electric privacy glass configured to change from a transparent mode to an opaque mode based on turning on or off an electrical current supplied to the privacy glass. In such an embodiment, enabling a zone 134 activates the privacy glass within the zone 134 to completely block the portion of the screen overlayed by the enabled zone 134.

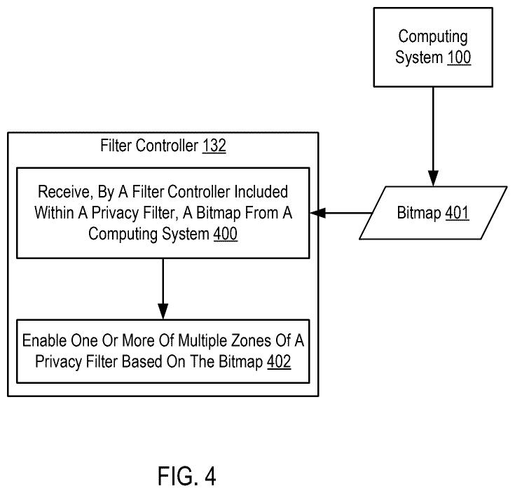

The example filter controller 132 of FIG. 1 is configured to control the operation of the privacy filter 130, including controlling which of the zones 134 are enabled at a given time. Enabling one or more zones 134 includes causing the enabled zone 134 to provide privacy to the user. Zones 134 may be enabled or disabled (turned on or off) by the filter controller 132. By controlling which of the zones 134 are enabled, the filter controller 132 is configured to control which portion (or portions) of the screen 120 are provided privacy from the privacy filter 130. In one embodiment, the filter controller 132 is configured to enable one or more zones 134 based on a received bitmap (e.g., bitmap 401 of FIG. 4). The bitmap may be received by the filter controller 132 from computing system 100. In another embodiment, the bitmap may be received by the filter controller 132 from another remote system.

In the example of FIG. 1, the multiple zones 134 are shown in a single column of zones 134. However, the example of FIG. 1 shows only a side view of the screen 120 and the privacy filter 130 (including the multiple zones 134). The zones 134 may be positioned in any pattern or configuration, such as a grid (with square zones 134), a hexagon array, or the like. The example of FIG. 1 shows thirteen zones 134 included within the privacy filter 130. In other embodiments, any number of zones 134 may be included within the privacy filter 130. For example, a grid of 100 zones 134 or more may be included within the privacy filter 130. In another example, the number of zones 134 included within the privacy filter 130 may correspond with (be equal to) a number of pixels included in a resolution of the screen 120. In such an example, the filter controller 132 is configured to provide privacy to portions of content on the screen on a pixel-by-pixel basis, allowing for precise control over which pixels have their viewing angle limited.

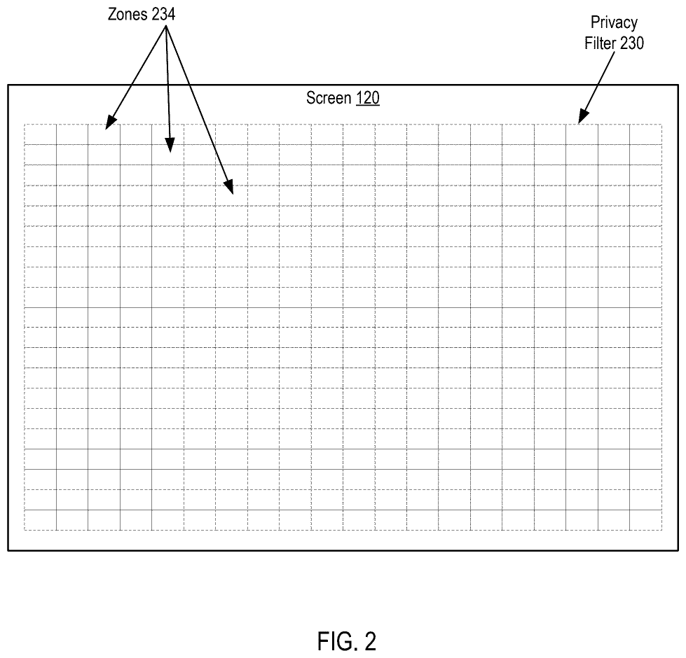

For further explanation, FIG. 2 sets forth an example line drawing of a screen (such as the screen 120 of FIG. 1) and an overlayed multi-zone electronic privacy filter (such as privacy filter 230) according to some embodiments of the present disclosure. The example of FIG. 2 shows a head-on view of the screen 120 with an overlaid privacy filter 230. The privacy filter 230 of FIG. 2 includes a grid of rectangular zones 234. In the example embodiment of FIG. 2, the privacy filter 230 includes 400 zones. In other embodiments, the privacy filter 230 may include additional zones (e.g., up to the number of pixels included in the resolution of the screen) or the privacy filter 230 may include fewer zones (e.g., as few as two zones splitting the screen into two sections). In the example of FIG. 2, each of the zones 234 is depicted as being uniform in size. In another embodiment, the zones 234 may comprise zones of varying sizes. In one example embodiment (not shown in FIG. 2), a privacy filter may include a single elongated zone at the bottom of the privacy filter, e.g., and may match a size and position of a user interface component (e.g., a taskbar in which open applications are indicated) that is shown on the screen 120. In such an embodiment, the privacy filter could provide privacy to the entire taskbar by activating only a single zone.

The example of FIG. 2 shows the zones 234 positioned in a grid pattern. However, in other embodiments, the zones 234 may be any other shape and/or may be positioned in any other pattern or orientation. In the example of FIG. 2, the zones 234 are shown as directly contacting or abutting one another without overlap. However, in some embodiments, one or more zones 234 may overlap (e.g., a portion of the screen 120 may be overlaid with two or more zones 234). In some embodiments, one or more zones 234 may be separated from one another by a given distance without a privacy zone 234 therebetween (e.g., a portion of the screen 120 may not be overlaid with a zone 234, and thus the portion may not be able to be shielded from view from persons other than the user of the screen 120). In one embodiment, all of the zones 234 include a same type of privacy filter. In another embodiment, some zones 234 may comprise a different type of privacy filter than other zones 234. For example, one or more zones 234 may provide limited viewing angles of content beneath the enabled zones 234 while other zones 234 may provide full blockage (by becoming opaque) to the content beneath them when enabled.

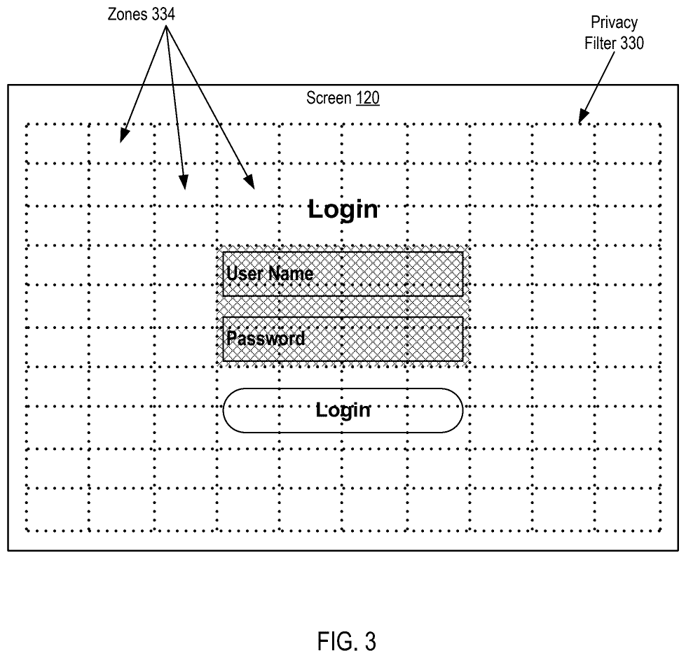

For further explanation, FIG. 3 sets forth a line drawing of another screen and an overlayed multi-zone electronic privacy filter (such as privacy filter 330) according to some embodiments of the present disclosure. The example of FIG. 3 differs from FIG. 2 in that the screen 120 of FIG. 3 is shown as displaying a login screen. The size of the zones 334 in FIG. 3 are larger than the zones 234 of FIG. 2. The example of FIG. 3 shows the zones 334 overlaying the user name and password input fields as being enabled, thereby providing a limited viewing angle of that portion of the screen 120. In such an example, the filter controller 132 may receive a bitmap from the computing system, where the bitmap includes pixel coordinates corresponding with the portions of the screen 120 displaying the user name and password input fields. In such an example, the filter controller 132 is configured to enable only the zones 334 corresponding to the portion of the screen 120 indicated in the bitmap, thereby blocking the viewing angle of the login user account information while still allowing the remainder of the login screen (and any background surrounding the login input fields) to be seen at any viewing angle.

The example of FIG. 3 shows the entire input fields blocked out by the enabled zones 334. In another embodiment, the filter controller 132 is configured to enable only the zones 334 which cover the text input by the user into those fields. By blocking only those zones 334 (instead of also blocking all the zones 334 overlaying any part of the input fields), the filter controller 132 is configured to enable the lowest number of zones 334 required to provide the needed privacy, thereby lowering power consumption. In another embodiment, where the size and number of the zones 334 corresponds with the number of pixels, the filter controller 132 is configured to enable zones 334 to block out only the pixels that make up the text input by the user into the fields.

For further explanation, FIG. 4 sets forth a flow chart illustrating an exemplary method of controlling a multi-zone electronic privacy filter according to embodiments of the present disclosure. The method of FIG. 4 includes receiving 400, by a filter controller 132 included within a privacy filter 130, a bitmap 401 from a computing system 100. Receiving 400 a bitmap 401 may be carried out by the filter controller 132 included within the privacy filter (e.g., privacy filter 130) receiving the bitmap from the computing system 100 comprising the screen that the privacy filter 130 overlays. The received bitmap 401 may include one or more sets (or arrays) of pixel coordinates on the screen. The portions of the screen 120 defined by the bitmap 401 (and included pixel coordinates thereof) may be associated with sensitive data or images that are to be blocked or have a view thereof limited by the privacy filter 130.

The method of FIG. 4 also includes enabling 402 one or more of multiple zones (e.g., zones 134) of a privacy filter 130 based on the bitmap 401. Enabling 402 one or more of multiple zones 134 of a privacy filter 130 may be carried out by filter controller 132 selecting one or more zones 134 of the privacy filter 130 that correspond to the bitmap 401 (e.g., selecting the filter zones 134 which overlay the portions of the screen defined by the bitmap 401). For example, the filter controller 132 may receive a bitmap that identifies the portions of a screen which include password or personal account information, and the filter controller 132 may respond to receiving the bitmap by enabling one or more filter zones 134 of the privacy filter 130 that overlay the identified portions of the screen 130. By selectively enabling the zones 134 of the privacy filter 130, the identified portions of the screen 120 (e.g., portions identified according to the bitmap 401) may have a viewing angle thereof that is limited and/or obstructed from view entirely (depending on the type of filter included within the privacy filter 130).

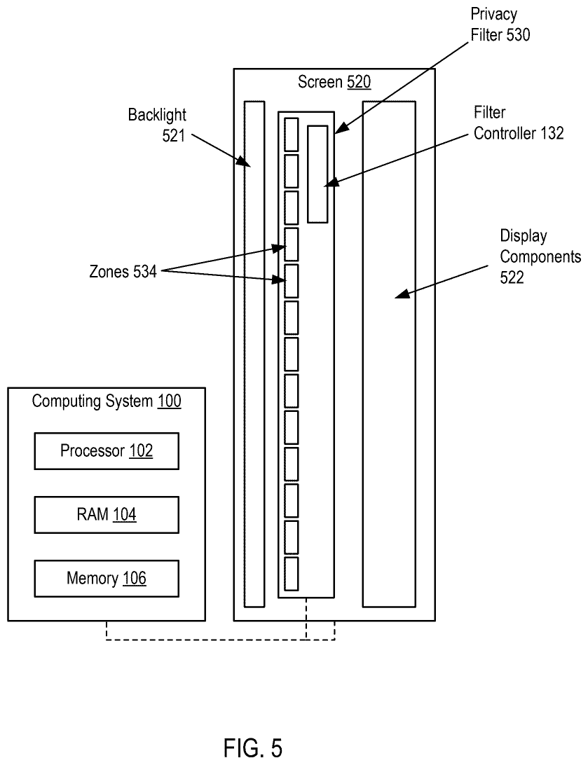

For further explanation, FIG. 5 sets forth an example line drawing of another system configured for a multi-zone electronic privacy filter in accordance with embodiments of the present disclosure. The example of FIG. 5 differs from the example system of FIG. 1 in that the example system of FIG. 1 depicts the privacy filter on a user-side of the screen while the example system of FIG. 5 depicts the privacy filter internal to the screen. Specifically, the example system of FIG. 5 includes a computing system 100, a screen 520 coupled to the computing system, and a privacy filter 530 coupled to the screen. In the example of FIG. 5, the privacy filter 530 is included within the screen 520 between the backlight 521 of the screen 520 and the display components 522 of the screen 520. In one embodiment, the screen 520 may be an LCD screen, e.g., and the display components 522 may include one or more of polarizers, LCD circuits, anodes, liquid crystals, cathodes, color filters, or the like. In such an example, the zones 534 of the privacy filter 530 underlay the pixels of the screen 520.

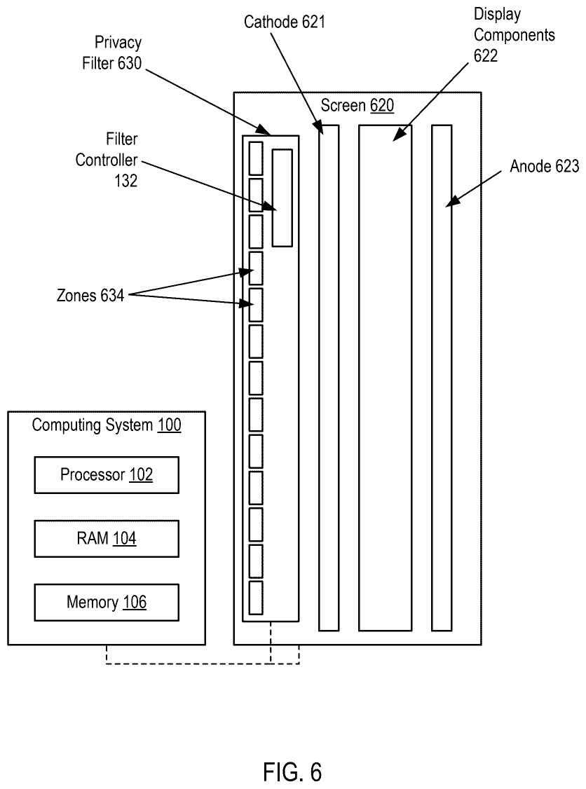

For further explanation, FIG. 6 sets forth an example line drawing of another system configured for a multi-zone electronic privacy filter in accordance with embodiments of the present disclosure. The example of FIG. 5 differs from the example system of FIG. 5 in that the example system of FIG. 5 depicts the privacy filter internal to an example screen having a backlight (e.g., an LCD screen) while the example system of FIG. 6 depicts the privacy filter internal to an example screen that does not include a backlight (e.g., an OLED screen). Specifically, the example system of FIG. 6 includes a computing system 100, a screen 620 coupled to the computing system, and a privacy filter 630 coupled to the screen. In the example of FIG. 6, the privacy filter 630 is included within the screen 620 on a side of a cathode 621 of the screen 520 that is opposite from the anode 623. In one embodiment, the screen 620 may be an OLED screen, e.g., and the display components 622 between the cathode 621 and anode 623 may include one or more of an electron injection layer, an electron transfer layer, an emission layer, a hole transfer layer, a hole injection layer, or the like. In such an example, the zones 634 of the privacy filter 630 underlay the pixels of the screen 620.

In view of the explanations set forth above, readers will recognize that the benefits of a multi-zone electronic privacy filter according to embodiments of the present disclosure include:
Increasing user privacy by selectively filtering only portions of the screen which require privacy, thereby allowing the remainder of the screen to be fully seen.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

It will be understood from the foregoing description that modifications and changes may be made in various embodiments of the present disclosure without departing from its true spirit. The descriptions in this specification are for purposes of illustration only and are not to be construed in a limiting sense. The scope of the present disclosure is limited only by the language of the following claims.

What is claimed is:

1. An apparatus comprising:
a privacy filter coupled to a screen of a computing system, wherein the privacy filter includes:
a plurality of zones; and
a filter controller configured to control which of the plurality of zones of the privacy filter are enabled based on a bitmap received from the computing system.

2. The apparatus of claim 1, wherein the privacy filter overlays the screen of the computing system.

3. The apparatus of claim 1, wherein the privacy filter is between a backlight of the screen and a polarizer of the screen.

4. The apparatus of claim 1, wherein enabling a privacy filter zone of the plurality of zones limits a viewing angle of a portion of the screen overlayed by the privacy filter zone.

5. The apparatus of claim 1, wherein the privacy filter includes a number of zones that is equal to a total number of pixels included in the screen.

6. The apparatus of claim 1, wherein the plurality of zones are positioned in a grid pattern within the privacy filter.

7. The apparatus of claim 1, wherein the filter controller is communicatively coupled to the computing system.

8. The apparatus of claim 1, wherein each zone of the plurality of zones includes one or more electronic polarizers.

9. A system comprising:
a processor;
a screen; and
a multi-zone electric privacy filter coupled to the screen, wherein the multi-zone electric privacy filter includes:
a plurality of zones; and
a filter controller configured to control which of the plurality of zones of the multi-zone electric privacy filter are enabled based on a bitmap received from the processor.

10. The system of claim 9, wherein the multi-zone electric privacy filter overlays the screen.

11. The system of claim 9, wherein the privacy filter is between a backlight of the screen and a polarizer of the screen.

12. The system of claim 9, wherein enabling a privacy filter zone of the plurality of zones limits a viewing angle of a portion of the screen overlayed by the privacy filter zone.

13. The system of claim 9, wherein the multi-zone electric privacy filter includes a number of zones that is equal to a total number of pixels included in the screen.

14. The system of claim 9, wherein each of the plurality of zones are positioned in a grid pattern within the multi-zone electric privacy filter.

15. The system of claim 9, wherein the filter controller is communicatively coupled to the processor.

16. The system of claim 9, wherein each zone of the plurality of zones includes one or more electronic polarizers.

17. A method comprising:
receiving, by a filter controller included within a privacy filter, a bitmap from a computing system, wherein the privacy filter is coupled to a screen of the computing system; and
enabling one or more of a plurality of zones of the privacy filter based on the bitmap.

18. The method of claim 17, wherein the privacy filter overlays the screen of the computing system.

19. The method of claim 17, wherein enabling a privacy filter zone of the plurality of zones limits a viewing angle of a portion of the screen overlayed by the privacy filter zone.

20. The method of claim 17, wherein the privacy filter includes a number of zones that is equal to a total number of pixels included in the screen.
